(19) United States
(12) Patent Application Publication
(10) Pub. No.: US 2012/0188030 A1
(43) Pub. Date: Jul. 26, 2012

(54) WAVEGUIDE CONVERSION DEVICE

(75) Inventors: Jie LIU, Wuhan (CN); Cui GUO, Shenzhen (CN); Wenxin YUAN, Shenzhen (CN); Tiezhu YU, Shenzhen (CN)

(73) Assignee: HUAWEI TECHNOLOGIES CO., LTD., Shenzhen (CN)

(21) Appl. No.: 13/439,035

(22) Filed: Apr. 4, 2012

Related U.S. Application Data
(63) Continuation of application No. PCT/CN2010/079264, filed on Nov. 30, 2010.

(30) Foreign Application Priority Data
Nov. 30, 2009 (CN) 200910188486.5

(51) Int. Cl. H01P 3/08

(52) U.S. Cl. 333/238

(57) ABSTRACT

Embodiments of the present application disclose a waveguide conversion device. The waveguide conversion device includes: a multi-layer circuit board; and a waveguide cavity and a metal reflection cavity, located at two lateral sides of the multi-layer circuit board. The waveguide cavity and the metal reflection cavity are embedded in the multi-layer circuit board. The multi-layer circuit board is disposed with a micro strip line or a strip line and a match patch connected to the micro strip line or the strip line. The match patch is located in the waveguide cavity.

### CROSS-REFERENCE TO RELATED APPLICATIONS

This application is a continuation of International Application No. PCT/CN2010/079264, filed on Nov. 30, 2010, which claims priority to Chinese Patent Application No. 200910188486.5, filed on Nov. 30, 2009, both of which are hereby incorporated by reference in their entireties.

### FIELD OF THE APPLICATION

The present application relates to the field of electronic communications technologies, and in particular, to a waveguide conversion device.

### BACKGROUND OF THE APPLICATION

A waveguide conversion device is used in a microwave transceiver system, as shown in FIG. 1. an existing waveguide conversion device is disposed on a two-layer circuit board 90, and the two-layer circuit board is disposed with a micro strip line match patch 92, and a waveguide cavity 91 and a metal reflection cavity 93 are disposed at two lateral sides of the two-layer circuit board 90.

To achieve communication connection with a transceiver system located at a multi-layer circuit board, the waveguide conversion device needs to be adhered to the multi-layer circuit board or is connected to the multi-layer circuit board by using a connector.

However, after the waveguide conversion device is adhered to the multi-layer circuit board, the two-layer circuit board where the waveguide conversion device is located needs to be electrically connected to the transceiver system of the multi-layer circuit board. Therefore, when the two-layer board is assembled to the multi-layer board, the requirement for accuracy of positioning is high, the assembly is complex, and performance consistency is poor.

### SUMMARY OF THE APPLICATION

Embodiments of the present application provide a waveguide conversion device, where the waveguide conversion device is disposed on a multi-layer circuit board, so that good electrical performance consistency between the waveguide conversion device and components of the multi-layer circuit board can be achieved, and assembly difficulty can be reduced.

The embodiments of the present application adopt the following technical solutions.

A waveguide conversion device includes: a multi-layer circuit board; and a waveguide cavity and a metal reflection cavity located at two lateral sides of the multi-layer circuit board. The waveguide cavity and the metal reflection cavity are embedded in the multi-layer circuit board. The multi-layer circuit board is disposed with a micro strip line or a strip line, and a match patch connected to the micro strip line or the strip line. The match patch is located in the waveguide cavity.

A communication apparatus includes: a multi-layer circuit board, disposed with a transceiver system; and a waveguide conversion device. The waveguide conversion device is electrically connected to the transceiver system.

The transceiver system is configured to receive and send a communication signal.

The waveguide conversion device includes: a multi-layer circuit board; and a waveguide cavity and a metal reflection cavity located at two lateral sides of the multi-layer circuit board. The waveguide cavity and the metal reflection cavity are embedded in the multi-layer circuit board. The multi-layer circuit board is disposed with a micro strip line or a strip line, and a match patch connected to the micro strip line or the strip line. The match patch is located in the waveguide cavity

The technical solutions have the following advantages.

In the embodiments of the present application, a waveguide conversion device is disposed on a multi-layer circuit board, so that the waveguide conversion device and a transceiver system can be conveniently integrated on a multi-layer circuit board, thereby improving the electrical performance consistency between the waveguide conversion device and the transceiver system or other components on the multi-layer circuit board and reducing assembly difficulty.

### BRIEF DESCRIPTION OF THE DRAWING

To illustrate the technical solutions according to the embodiments of the present application or in the prior art more clearly, the accompanying drawings for describing the embodiments or the prior art are introduced briefly in the following. Apparently, the accompanying drawings in the following description are only about some embodiments of the present application, and persons of ordinary skill in the art can derive other drawings from the accompanying drawings without creative efforts.

FIG. 1 is a schematic diagram of a waveguide conversion device;

FIG. 2 is a schematic diagram of an embodiment of a waveguide conversion device according to the present application;

FIG. 3 is a schematic diagram of the embodiment in FIG. 2 from another perspective;

FIG. 4 is a schematic diagram of another embodiment of a waveguide conversion device according to the present application;

FIG. 5 is a schematic diagram of the embodiment in FIG. 4 from another perspective; and

FIG. 6 is a schematic diagram of an embodiment of a communication device according to the present application.

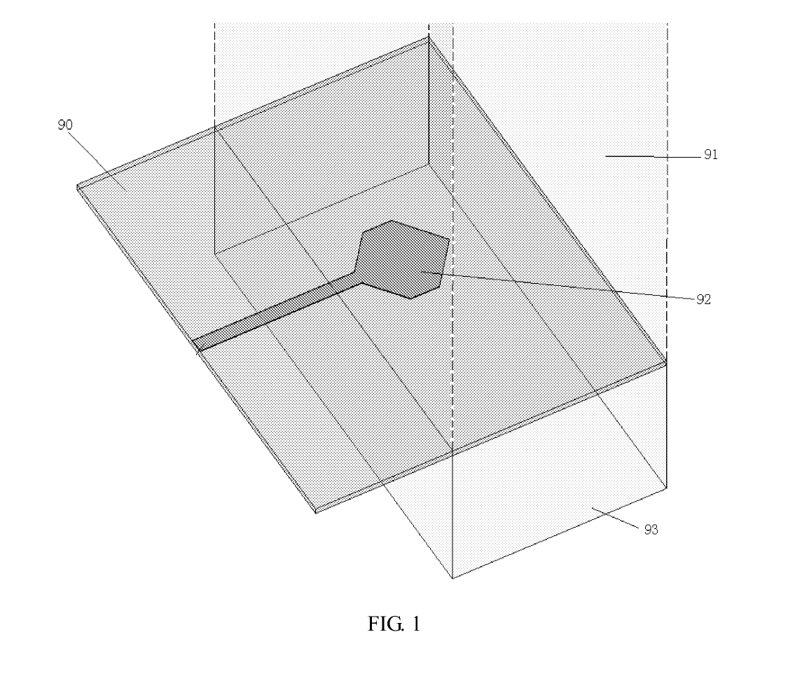

### DETAILED DESCRIPTION OF THE EMBODIMENTS

The technical solutions of the present application will be clearly and completely described in the following with reference to the accompanying drawings. It is obvious that the embodiments to be described are only a part rather than all of the embodiments of the present application. All other embodiments obtained by persons of ordinary skill in the art based on the embodiments of the present application without creative efforts shall fall within the protection scope of the present application.

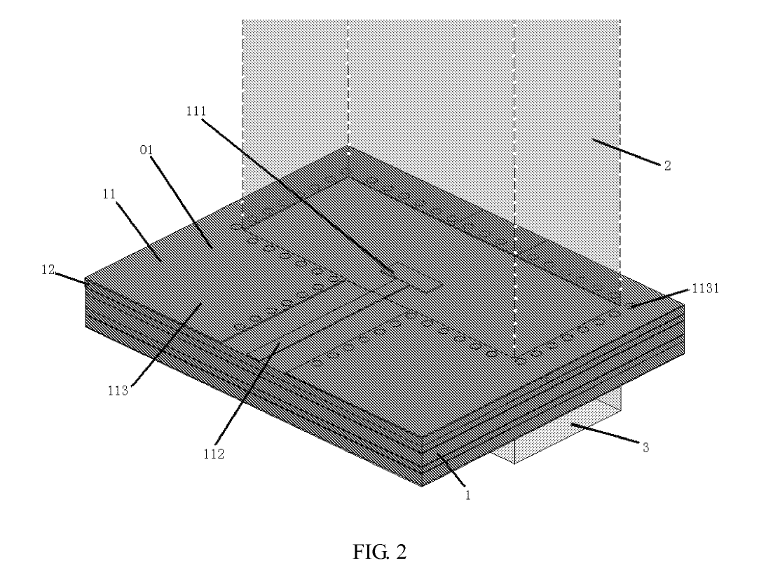

As shown in FIG. 2, an embodiment of the present application provides a waveguide conversion device, where the waveguide conversion device includes: a multi-layer circuit board 1; and a waveguide cavity 2 and a metal reflection cavity 3 located at two lateral sides of the multi-layer circuit board 1. The metal reflection cavity 3 and the waveguide cavity 2 are embedded in the multi-layer circuit board 1. The multi-layer circuit board 1 is disposed with a micro strip line or a strip line, and a match patch 111 connected to the micro strip line or the strip line. The match patch 111 is located in the waveguide cavity 2.

In the embodiment of the present application, the waveguide conversion device is disposed on the multi-layer circuit board, so that the waveguide conversion device and a transceiver system can be conveniently integrated on a multi-layer circuit board, thereby improving the electrical performance consistency between the waveguide conversion device and the transceiver system or other components on the multi-layer circuit board and reducing assembly difficulty.

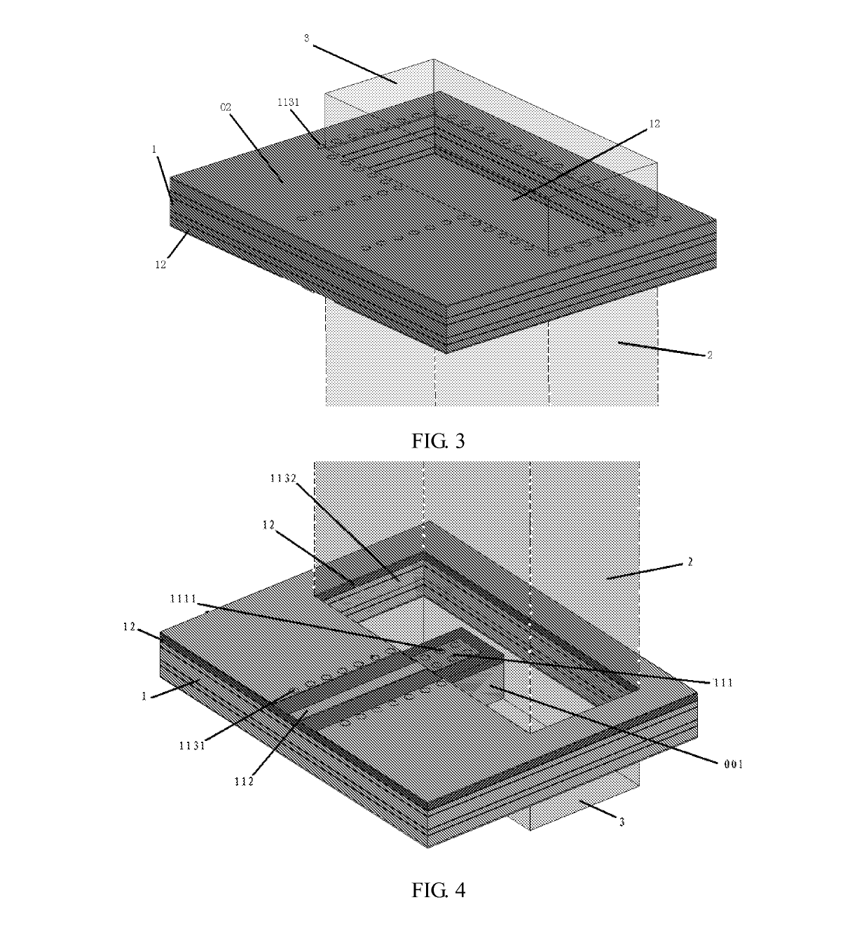

As shown in FIG. 2 and FIG. 3, in an embodiment of the present application, a multi-layer circuit board may be disposed with a micro strip line 112, a surface which is at one side of the multi-layer circuit board 1 and on which a waveguide cavity 2 is disposed is a first surface 01, the first surface 01 is disposed with a conductor layer 11, and the conductor layer 11 includes: the micro strip line 112 and a match patch 111 connected to the micro strip line.

Furthermore, the conductor layer 11 located on the first surface 01 may further include a surface layer ground 113, where the surface layer ground 113 is located at two lateral sides of the micro strip line 112 and the periphery of a metal reflection cavity 3.

Additionally, the micro strip line and the surface layer ground at two lateral sides of the micro strip line are disposed in the form of coplanar waveguide. In this case, a space between the micro strip line and the surface layer ground may be about 1H times the thickness of a medium between the micro strip line and a referred internal layer ground in the absence of the surface layer ground; and when the space between the micro strip line and the surface layer ground is so small that the characteristic impedance therebetween is influenced, coplanar waveguide is formed.

If the micro strip line between the waveguide conversion device and a microwave transceiver circuit is in the form of coplanar waveguide (CPW), then through the coplanar waveguide, the micro strip line and the surface layer ground at two lateral sides form a electrical field distribution region, the surface layer ground forms a main returning current path, and the returning current path is shortened, and at the same time, high order mode interference is reduced, so that a working frequency band is widened, and a resonance point gets away from frequency selective bandwidth, thereby reducing equipment output loss and improving system performance. As the bandwidth is very wide, a problem that the waveguide conversion device cannot work normally due to frequency offset caused by processing can be further solved.

As shown in FIG. 2 and FIG. 3, a metal ground may be disposed at the periphery of the waveguide cavity 2 or the metal reflection cavity 3. Additionally, the circuit board 1 defines a metal ground at the surface layer ground 113 and close to an edge of the micro strip line 112. The metal ground may be an opened ground through hole 1131, and the ground through hole penetrate the overall thickness of the circuit board 1.

As shown in FIG. 2 and FIG. 3, in this embodiment, an inner side of the conductor layer 11 of the first surface 01 of the multi-layer circuit board 1 may be a high-frequency dielectric layer 12. The multi-layer circuit board 1 is a circuit board of more than two layers, besides the high-frequency dielectric layer, the other part of the multi-layer circuit board may be a board with common structure, and may also be a high-frequency dielectric layer.

As shown in FIG. 2, in the embodiment of the present application, the waveguide cavity 2 and the metal reflection cavity 3 are located at corresponding positions on surfaces at two lateral sides of the circuit board 1. That is to say, the project of the waveguide cavity 2 and the projection of the metal reflection cavity 3 on a plane parallel to the circuit board 1 may be completely overlapped with each other, and may also be mostly overlapped with each other.

As shown in FIG. 2 and FIG. 3, in another embodiment of the present application, a surface which is at one side of the multi-layer circuit board 1 and on which the metal reflection cavity 3 is disposed is a second surface 02. The waveguide cavity 2 is embedded in the conductor layer 11 of the first surface 01 of the multi-layer circuit board 1, the metal reflection cavity 3 is embedded in the second surface 02 of the multi-layer circuit board 1 and reaches the high-frequency dielectric layer 12, and the second surface 02 is a dielectric layer.

Furthermore, the metal ground on the periphery of the metal reflection cavity 3 may define a ground through hole 1131, or have a metalized side wall formed by metalizing a side wall of the metal reflection cavity 3 located in the multi-layer circuit board 1.

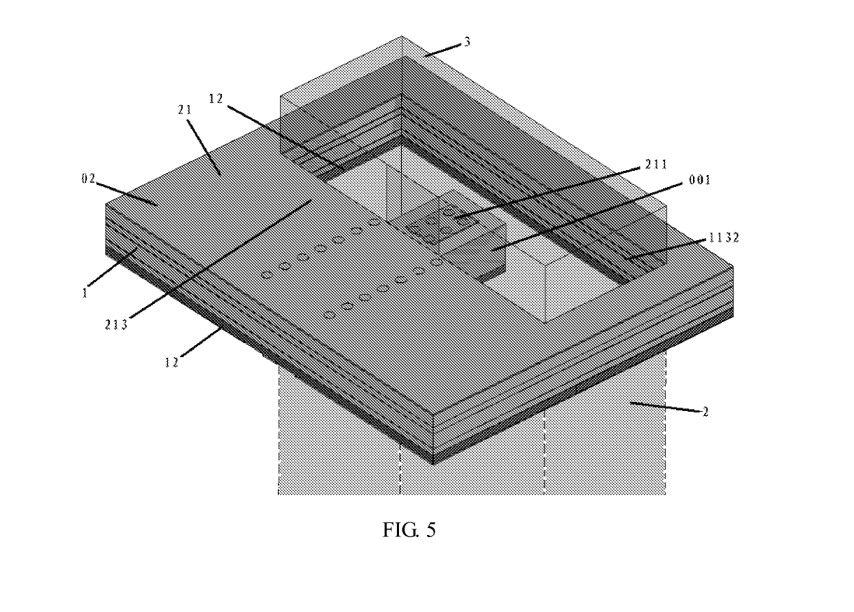

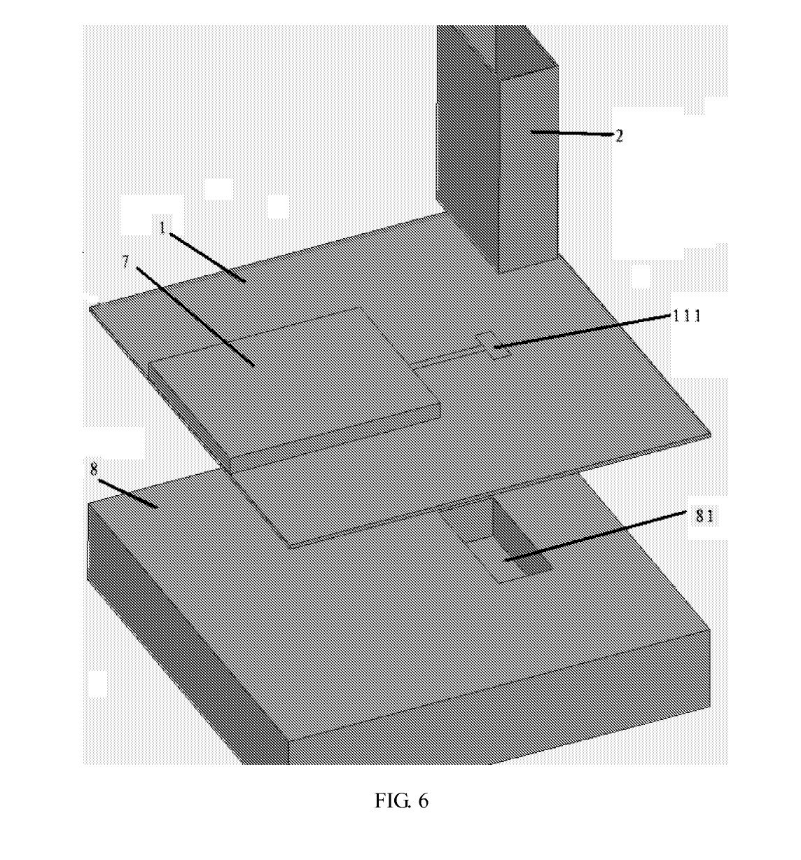

As shown in FIG. 4 and FIG. 5, in another embodiment of the present application, the second surface 02 has a conductor layer 21, and the conductor layer 21 of the second surface 02 includes a match patch 211 located in the metal reflection cavity 3, the match patch 111 of the first surface 01, the match patch 211 of the second surface, and a match block 001 formed by a part of the multi-layer circuit board between the two match patches. The match block 001 defines a metal group at a position that is covered by the match patch, and the metal ground penetrates through a part of the multi-layer circuit board between the two match patches. The waveguide cavity 2 is in communication with the metal reflection cavity 3, and the match block 001 is located in the metal reflection cavity 3 and the waveguide cavity 2.

The conductor layer 21 of the second surface 02 may further include a bottom layer ground 213 located at the periphery of the metal reflection cavity 3. The metal ground of the match block 001 may be an opened ground through hole 1111.

As shown in FIG. 5, in this embodiment, a part of the multi-layer circuit board 1 that is located between the waveguide cavity 2 and the metal reflection cavity 3 is hollowed out in the manner of window cutting, and merely has the medium at a place where the micro strip match block 001 is disposed in suspension, for supporting the match patches. By disposing a metal ground at the position of the match block 001 that is covered by the match patch, the metal ground may be a metalized through hole 1111 that penetrates the overall thickness of the multi-layer circuit board (referring to FIG. 4), and the plural layers of the multi-layer circuit board between the two match patches are firmly connected through the metalized through hole.

As shown in FIG. 4 and FIG. 5, in this embodiment, the circuit board 1 may be disposed with a metal ground at the periphery of the metal reflection cavity 3, and the metal ground penetrates the overall thickness of the circuit board. The metal ground on the periphery of the metal reflection cavity 3 may define a ground through hole, or have a metalized side wall 1132 formed by metalizing a side wall of a part of the multi-layer circuit board 1 that is located in the waveguide cavity 2 and the metal reflection cavity 3.

In this embodiment, the multi-layer circuit board may be disposed with a strip line, and the strip line is connected to the match block. A medium between the strip line and a reference ground is a high-frequency medium, and a medium of the other part of the multi-layer circuit board may also be a high-frequency medium, or a common medium.

A conductor layer that is in the match block and is connected to the strip line and a conductor layer where the strip line is located may be the same conductor layer in the circuit board.

It should be noted that, in the embodiments of the present application, the multi-layer circuit board may also be disposed with a transceiver system or other electronic devices. That is to say, a micro strip line waveguide device can share a multi-layer circuit board with a transceiver system or other electronic devices.

The conductor layer may be a copper conductor layer, for example, a copper layer or a copper pattern layer.

The present application further provides an embodiment of a communication apparatus. The communication apparatus includes a multi-layer circuit board 1, where the multi-layer circuit board 1 is disposed with a transceiver system 7 and a waveguide conversion device. The waveguide conversion device is electrically connected to the transceiver system.

The transceiver system 7 is configured to receive and send a communication signal.

The waveguide conversion device is the waveguide conversion device described in the foregoing embodiment, and is not described again herein.

The communication apparatus further includes a metal structure member 8. A notch 81 is defined in the metal structure member, and the notch 81 is in communication with the metal reflection cavity of the waveguide conversion device.

In this embodiment, the communication apparatus may be a point-to-point or point-to-multipoint transmission device using microwaves in a transmission system such as a wireless system, a network system or other systems.

Only several embodiments of the present application have been illustrated above. Those skilled in the art can make various modifications or variations to the present application according to the disclosure of the application document without departing from the spirit and the scope of the present application.

What is claimed is:

1. A waveguide conversion device, comprising: a multi-layer circuit board, a waveguide cavity and a metal reflection cavity located at two lateral sides of the multi-layer circuit board, wherein the waveguide cavity and the metal reflection cavity are embedded in the multi-layer circuit board, the multi-layer circuit board has a micro strip line or a strip line, and a match patch connected to the micro strip line or the strip line, the match patch is located in the waveguide cavity.

2. The waveguide conversion device according to claim 1, wherein the multi-layer circuit board has the micro strip line, a surface of a lateral side of the multi-layer circuit board on which the waveguide cavity is disposed defines a first surface thereon, the first surface defines a conductor layer thereon, the conductor layer comprises the micro strip line and the match patch connected to the micro strip line.

3. The waveguide conversion device according to claim 1, wherein the conductor layer located on the first surface further comprises a surface layer ground, wherein the surface layer ground is located at two lateral sides of the micro strip line or a periphery of the metal reflection cavity.

4. The waveguide conversion device according to claim 3, wherein the micro strip line and the surface layer ground at two lateral sides of the micro strip line define a coplanar waveguide thereon.

5. The waveguide conversion device according to claim 1, wherein a periphery of the waveguide cavity or a periphery of the metal reflection cavity defines a metal ground.

6. The waveguide conversion device according to claim 5, wherein the metal ground at the periphery of the metal reflection cavity is a metalized side wall of the metal reflection cavity located in the multi-layer circuit board.

7. The waveguide conversion device according to claim 1, wherein the multi-layer circuit board defines a metal ground on a surface layer ground and close to an edge of the micro strip line.

8. The waveguide conversion device according to claim 1, wherein an inner side of a conductor layer of a first surface of the multi-layer circuit board is a high-frequency dielectric layer.

9. The waveguide conversion device according to claim 8, wherein a surface of the multi-layer circuit board on which the metal reflection cavity is disposed is a second surface, the waveguide cavity is embedded in the conductor layer of the first surface of the multi-layer circuit board, the metal reflection cavity is embedded in the second surface of the multi-layer circuit board and reaches the high-frequency dielectric layer, and the second surface is a dielectric layer.

10. The waveguide conversion device according to claim 1, wherein a second surface defines a conductor layer thereon, and the conductor layer of the second surface comprises a match patch located in the metal reflection cavity; and
a match patch of a first surface, a match patch of the second surface, and a part of the multi-layer circuit board between the two match patches form a match block, the match block defines a metal group in a position that is covered by the match patch, the waveguide cavity is in communication with the metal reflection cavity, and the match block is located in the metal reflection cavity and the waveguide cavity.

11. The waveguide conversion device according to claim 10, wherein the conductor layer of the second surface further comprises a bottom layer ground located at a periphery of the metal reflection cavity.

12. The waveguide conversion device according to claim 10, wherein a periphery of the metal reflection cavity is disposed with a metal ground, the metal ground at the periphery of the metal reflection cavity is a metalized side wall of a part of the multi-layer circuit board located in the waveguide cavity and the metal reflection cavity.

13. The waveguide conversion device according to claim 10, wherein the multi-layer circuit board has a strip line, the strip line is connected to the match block, and a medium between the strip line and a reference ground is a high-frequency medium.

14. A communication apparatus, comprising: a multi-layer circuit board comprises a transceiver system and the waveguide conversion device according, he waveguide conversion device is electrically connected to the transceiver system;
the transceiver system is configured to receive and send a communication signal; and
wherein the waveguide conversion device, comprising: a multi-layer circuit board, a waveguide cavity and a metal reflection cavity located at two lateral sides of the multi-layer circuit board, the waveguide cavity and the metal reflection cavity are embedded in the multi-layer circuit board, the multi-layer circuit board has a micro strip line or a strip line, and a match patch connected to the micro strip line or the strip line, the match patch is located in the waveguide cavity.

15. The communication apparatus according to claim 14, wherein the communication apparatus is a point-to-point or point-to-multipoint transmission apparatus using microwaves.
